(19) United States
(12) Patent Application Publication
(10) Pub. No.: US 2016/0093893 A1
(43) Pub. Date: Mar. 31, 2016

(54) CATHODE DEVICE FOR FUEL CELL

(71) Applicants: Typher Yom, Manhasset, NY (US); Jong Won Yom, Manhasset, NY (US)

(72) Inventors: Typher Yom, Manhasset, NY (US); Jong Won Yom, Manhasset, NY (US)

(21) Appl. No.: 14/563,468

(22) Filed: Dec. 8, 2014

Related U.S. Application Data
(60) Provisional application No. 62/057,006, filed on Sep. 29, 2014.

(51) Int. Cl. H01M 4/90; H01M 4/86; H01M 4/88

(52) U.S. Cl. CPC H01M 4/9083; H01M 4/8846; H01M 4/8867; H01M 4/8605

(57) ABSTRACT

An electrode for a fuel cell is disclosed. More particularly, the electrode includes a porous substrate and nitrogen-doped graphene included in the substrate. A method for making the electrode is also disclosed. The method involves providing a porous substrate and forming nitrogen-doped graphene in the substrate.

### CROSS-REFERENCE TO RELATED APPLICATION

The present application claims the priority of U.S. Provisional Application No. 62/057,006 filed Sep. 29, 2014, the disclosure of which is incorporated herein by reference in its entirety.

### FIELD OF THE INVENTION

The present invention relates to cathode devices and fuel cells equipped with same.

### BACKGROUND OF THE INVENTION

Various fuel cells have been developed in the past. Such fuel cells are equipped with electrodes to performing chemical reactions to generate electricity.

### SUMMARY OF THE INVENTION

In accordance with an embodiment of the present invention, a cathode device includes a porous substrate. Nitrogen-doped graphene is contained in or infused with the substrate. According to another embodiment, the present invention provides an electrode for a fuel cell containing the cathode device for carrying out a half-cell reaction, which is facilitated by the nitrogen-doped graphene.

In accordance with yet another embodiment, a method of making a cathode device includes the steps of providing a porous substrate and forming a nitrogen-doped graphene layer or layers in and/or on the substrate.

### BRIEF DESCRIPTION OF THE DRAWINGS

For a more complete understanding of the present invention, reference is made to the following detailed description of the invention considered in conjunction with the accompanying drawings, in which:

FIG. 1 is a schematic view of a fuel cell having a cathode constructed in accordance with an embodiment of the present invention;

FIG. 1A is an enlarged view of a section of the cathode shown in FIG. 1;

FIG. 2A is a top view of a porous matrix with graphite lines drawn thereover during a process for making the cathode shown in FIG. 1;

FIG. 2B is a top view of the porous matrix shown in FIG. 2A after the spreading or smearing of the graphite lines;

FIG. 2C is a top view of the porous matrix shown in FIG. 2B after the application of an aqueous solution of graphene oxide;

FIG. 3A is a cross-sectional view of a portion of the porous matrix shown in FIG. 2A;

FIG. 3B is a cross-sectional view of a portion of the porous matrix shown in FIG. 2B;

FIG. 3C is a cross-sectional view of a portion of the porous matrix shown in FIG. 2C;

FIG. 4 is a view of the porous matrix, schematically illustrating graphene oxide and/or graphite drawn into the matrix;

FIG. 5 is a schematic view of a container housing the matrix, which is subjected to microwave radiation in a gas filled environment;

FIG. 6 is a partial view showing a cathode constructed in accordance with another embodiment of the present invention; and

FIGS. 7 A and 7B are graphs showing voltage measurements obtained from a sample cathode device made in accordance with an embodiment of the present invention.

### DETAILED DESCRIPTION OF THE INVENTION

Various embodiments are disclosed herein; however, it is to be understood that the disclosed embodiments are merely illustrative of the disclosure that can be embodied in various forms. In addition, each of the examples given in connection with the various embodiments is intended to be illustrative, and not restrictive. Further, the figures are not necessarily to scale, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; exemplary embodiments are provided merely to be illustrative. Among other things, for example, subject matter may be embodied as methods, devices, components, combinations or systems. The following detailed description is, therefore, not intended to be taken in a limiting sense.

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Moreover, directional and positional phrases, such as “upper”, “lower”, “lateral”, “bottom”, “top”, “front”, “rear”, “downwardly”, “upwardly”, “laterally”, “axially”, etc., are used herein for illustration purposes only and should not be construed as limiting the scope of the present invention.

Although the present invention can be used in conjunction with any type of fuel cell, it is particularly suitable for use in connection with a metal-air fuel cell. Accordingly, the present invention will be described hereinafter in connection with such a fuel cell. It should be understood, however, that the following description is only meant to be illustrative of the present invention and is not meant to limit the scope of the present invention, which has applicability to other fuel cells, including polymer electrolyte membrane (PEM) fuel cells.

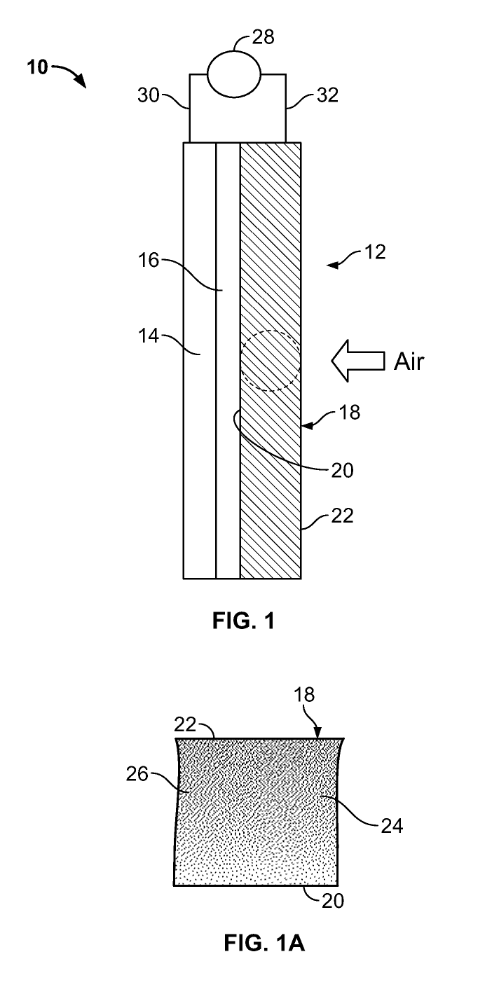

FIG. 1 schematically illustrates a fuel cell 10 constructed in accordance with an embodiment of the present invention. The fuel cell 10 includes a cathode 12 and an anode 14 for carrying out respective half-cell reactions for generating electricity. An electrolyte 16 is located between, and in contact with, the cathode 12 and the anode 14. The electrolyte 16 is selected from any electrolyte used in conventional fuel cells for transmitting protons and/or ions from the anode 14 to cathode 12. In one embodiment, the electrolyte 16 includes a phosphoric acid and/or potassium hydroxide solution. In another embodiment, water may be used as the electrolyte 16.

Now referring to FIGS. 1 and 1A, the cathode 12 includes a porous substrate or matrix 18 having an inner side 20 adjacent the anode 14 and an outer side 22 opposite the anode 14. The matrix 18 contains a plurality of interior pores 24, which are interconnected to each other, such that it is permeable by fuel sources and ions (e.g., water and elemental oxygen, protons and/or electrons). As will be described in greater detail below, the matrix 18 is infused with nitrogen-doped (“n-doped”) graphene layers 26 so as to provide reactive sites therein for carrying out a half-cell reaction. In one embodiment, the n-doped graphene 26 is infused substantially throughout the matrix 18 and retained in the interior pores 24. For instance, the concentration of the n-doped graphene 26 is substantially the same throughout the matrix 18. In another embodiment, such concentration may change within the matrix 18.

In yet another embodiment, the n-doped graphene 26 are infused with the matrix 18 such that their concentration is higher adjacent the outer side 22 of the matrix 18 and gradually decreases towards the inner side 20 (see, e.g., FIG. 1A). The n-doped graphene 26 is infused with the matrix 18 for the purpose of facilitating a cathode-side half-cell reaction in or within the cathode 12. In one embodiment, the n-doped graphene 26 catalyze the cathode-side half-cell reaction. Without being bound by any theory, it is believed that the n-doped graphene 26 is capable of catalyzing an oxygen reduction reaction (ORR) through which elemental oxygen, protons and electrons combine to form water (e.g., O₂+4H⁺+4e⁻→2H₂O). Other cathode-side half-cell reactions may be possible, including the alkaline four-electron pathway (i.e., O₂+2H₂O+4e^{-→}4OH⁻) and the acidic two-electron pathway (i.e., O₂ +2H⁺+2e⁻H₂O₂), depending on fuel sources, electrolytes, electrode materials and/or other variables.

In one embodiment, the n-doped graphene 26 is included in the matrix 18 in layer form (e.g., in layers) and/or is coated over the matrix 18. In yet another embodiment, the n-doped graphene 26 coats at least some of the pores 24 of the matrix 18, creating a three-dimensional coating/layer or coatings or layers of n-doped graphene within the matrix 18 and allowing the overlapping of nitrogen atoms in different layers of graphene. The coating of the n-doped graphene 26 creates an inner lining of n-doped graphene in the areas of the matrix 18 that form the pores 24. The oxygen molecules, which can enter into the pores 24, are attracted to the nitrogen in the n-doped graphene 26 at multiple angles, while some water (and protons) moves into the pores via capillary action, coming into contact with the oxygen. The electrons follow because the n-doped graphene is electrically conductive, allowing for the ORR to occur efficiently.

Still referring to FIG. 1, the outer side 22 of the cathode 12 is exposed such that fuel sources (e.g., air containing oxygen and/or water) can be supplied to the cathode 12. For instance, the cathode 12 is open to the air, i.e., open to the ambient environment, such that air can permeate into the matrix 18 through its interior pores 24. In one embodiment, the cathode 12 may include an air inlet port and an air outlet port spaced from each other for delivering a constant stream of air or other gas (i.e., pure oxygen, etc.) to the matrix 18.

As discussed above, the cathode 12 is constructed so as to facilitate delivery of fuel sources (e.g., air, oxygen, etc.) to the interior pores 24 of the matrix 18. More particularly, the matrix 18 is made from a porous material having a porosity sufficient to allow fuel sources to penetrate into and/or throughout the interior pores 24 and/or resulting waste chemicals (e.g., water) to be discharged therefrom. In other embodiments, the porous material may be rigid, electrically non-conductive, thermally conductive and/or wettable (e.g., liquid, such as water, can permeate into and/or throughout the matrix 18). In one embodiment, the matrix 18 is constructed such that the n-doped graphene 26 and/or liquid can be retained within the interior pores 24. The matrix material is selected from materials capable of providing an environment in which a cathode-side half-cell reaction can be carried out. In one embodiment, the porous material includes silicon carbide, aluminum oxide, paper and/or other suitably permeable materials. In another embodiment, the porous material includes silicon carbide having a grit size of about 220. In other embodiments, the matrix 18 may include porous substrates of silicon carbide and/or aluminum oxide having different grit sizes.

Referring back to FIG. 1, the anode 14 is constructed in a conventional manner. Accordingly, the anode 14 can be made from any material used in constructing conventional anodes used in metal-air fuel cells. In one embodiment, the anode 14 is a metal strip made from aluminum, iron, copper, silver and/or gold. In other embodiments the anode 14 may be formed of any metal that can react with the cathode 12. A half-cell reaction is carried out by the anode 14 such that the anode 14 is broken down into ions (e.g. positive metal ions and electrons). The electrons generated from this reaction are transmitted to a load 28 (e.g., an electrically powered device, or electrical storage device, such as a battery) via an electrical lead 30. The load 28 is electrically connected to the cathode 12 via an electrical lead 32 such that the electrons can be transmitted from the load 28 to the cathode 12. Without being bound by any theory, it is believed that ambient protons from the electrolyte 16 and the electrons from the anode half-reaction combine with oxygen at the cathode 12, generating water as a waste material which is discharged from cathode 12 via the interior pores 24.

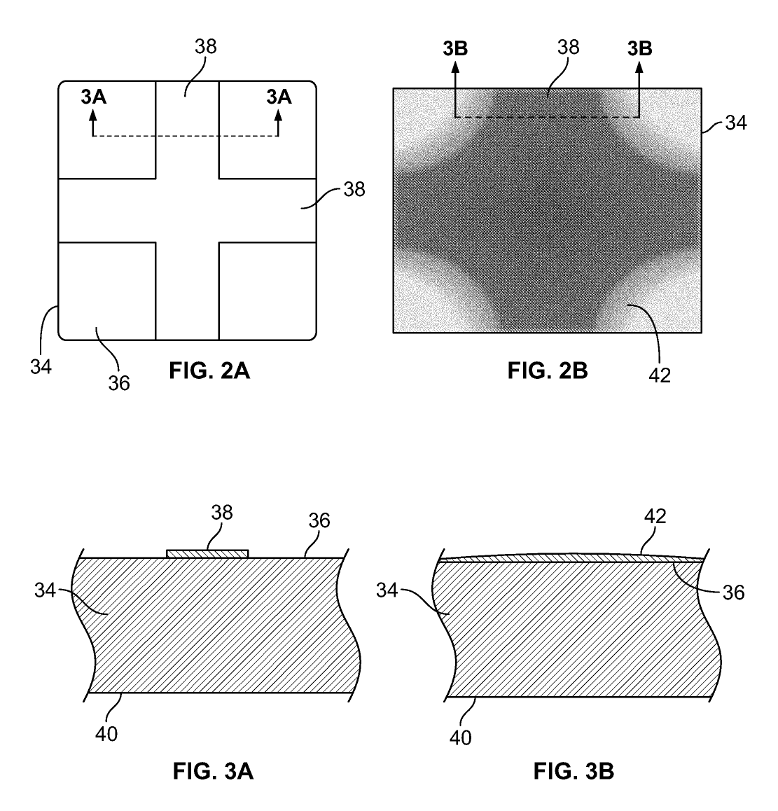

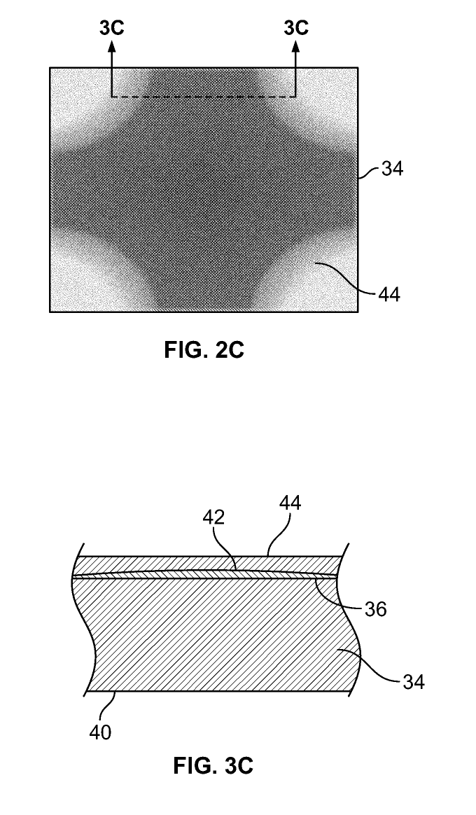

The cathode 12 of the present invention can be made by performing a nitrogen-doping process on the matrix 18 after the matrix 18 has been infused with graphene oxide. With reference to FIG. 2A, a suitable substrate 34 is selected as the starting material for the matrix 18. The substrate 34 can be of a desired size, shape and/or material based on various criteria, such as porosity, pore sizes, length, thermal conductivity, wettability, cost and/or availability. In one embodiment, the substrate 34 has a thickness ranging from about 10 mm to about 12 mm. In other embodiments, the substrate 34 may be provided with a different thickness. The substrate 34 may be generally square or rectangular in shape. However, the substrate 34 can be in any shape, so long as a sufficient surface area is provided for the coating of graphite and graphene oxide to create reactive sites sufficient for carrying out a half-cell reaction in the cathode 12. In one embodiment, the substrate 34 is made from silicon carbide, aluminum oxide, paper and/or other suitable materials (e.g., silicon carbide substrates sold by Sun Tiger® as part number GC220).

After a suitable starting substrate 34 has been selected, made, sized and/or shaped, graphite is applied to a surface 36 of the substrate 34 to form a plurality of graphite lines or patterns 38 on the substrate 34 (see FIGS. 2A and 3A). Other electrically conductive materials, such as metals, may be used. In one embodiment, the graphite lines 38 are drawn on the surface 36 with a standard conventional lead pencil, such as lead pencils sold by Dixon Ticonderoga Co., Heathrow, Fla., under the trademark DIXON TICONDEROGA®. In another embodiment, the graphite lines 38 may be sprayed or otherwise applied to the surface 38 of the substrate 34 according to a conventional method known in the art. In another embodiment, graphite can be applied to an opposite surface 40 of the substrate 34 (in addition to the surface 36) in a similar manner.

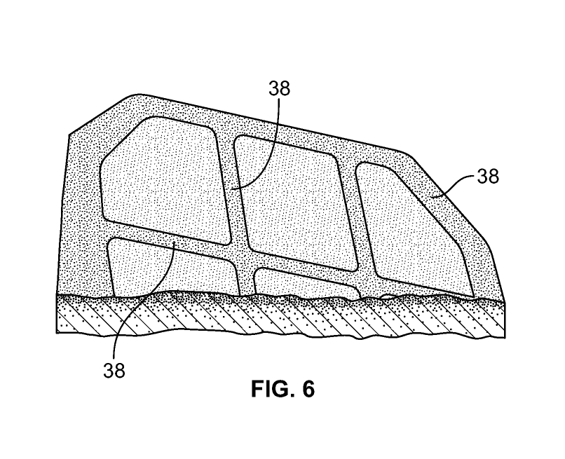

The graphite lines 38 can be in any suitable patterns, sizes and/or shapes. In one embodiment, the graphite lines 38 are provided with a sufficient width, forming a cross pattern (see FIG. 2A). In another embodiment, the graphite lines 38 may include graphite lines drawn or applied along the outer edges of the substrate 34 (see FIG. 6). In yet another embodiment, the entire surface 36 of the substrate 34 may be applied with a layer or layers of graphite.

After the graphite lines 38 are formed on the substrate 34, graphite particles in the graphite lines 38 are distributed or spread over substantially the entire surface 36 of the substrate 34 so as to form a graphite layer 42 substantially covering the substrate 34 (see FIGS. 2A and 3B). In one embodiment, such distribution may be performed mechanically by spreading or smearing the graphite lines 38 over the surface 36 of the substrate 34 with a smooth object such as, for instance, vinyl, rubber or other suitable material known in the art. Once the graphite layer 42 is formed, the substrate 34 is saturated with water. In one embodiment, distilled water, deionized water or another conventional type of water is utilized. The saturation may be carried out in any suitable conventional container or by other means known in the art. For instance, water may be sprayed, dropped and/or gently poured onto the graphite layer 42.

Once the substrate 34 is sufficiently saturated with water, an aqueous solution containing graphene oxide is applied to or coated over the surface 36 of the substrate 34 (see FIGS. 2C and 3C). In one embodiment, the graphene oxide and water can be mixed together to form the solution having a graphene oxide concentration ranging from about 0.5 mg/ml to about 6 mg/ml. In another embodiment, other graphene oxide concentrations can be used. In one embodiment, the graphene oxide solution can be applied to both surfaces of the substrate 34 (i.e., the surface 36 containing the graphite layer 42 and the opposite surface 40). The graphene oxide solution can be applied to the substrate 34 in any conventional manner known in the art (e.g., using a conventional roller).

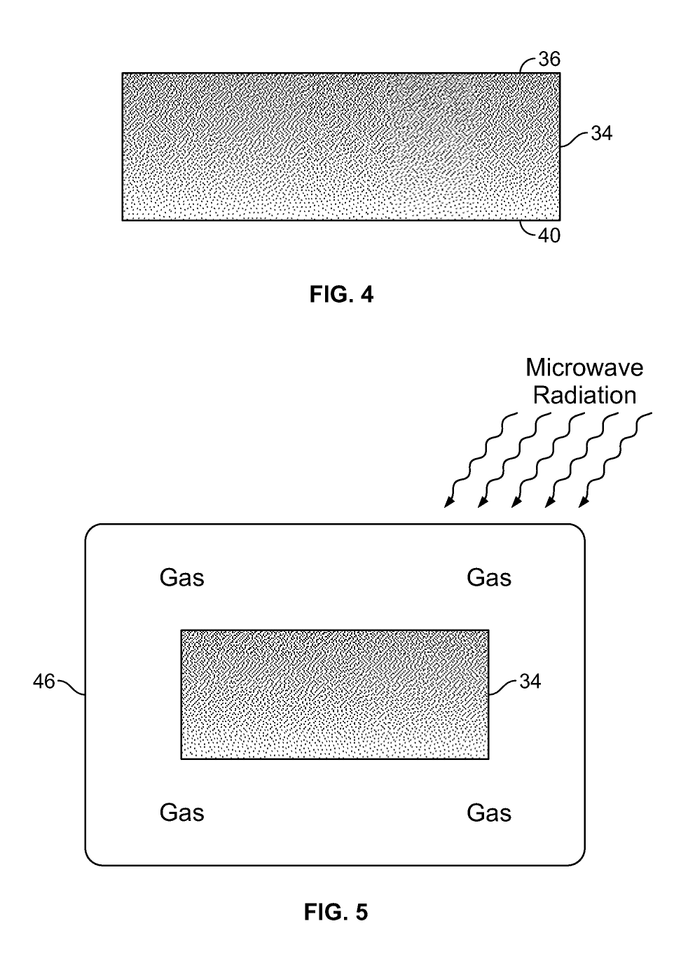

Once adequately coated, the graphene oxide layer 44 and graphite layer 42 are drawn into interior pores of the substrate 34. More particularly, an absorbent material (e.g., paper towel, sponge, etc.) is applied to a side of the substrate 34 opposite from the graphene oxide layer 44 and/or the graphite layer 42. In the example shown in FIG. 3C, the absorbent material is applied to the surface 40 of the substrate 34. As moisture is withdrawn from the substrate 34 into the absorbent material, a suction or “pulling” force acts on graphene oxide and graphite materials in the graphene oxide and graphite layers 44, 42, thereby causing same to be drawn into the interior pores of the substrate 34 and adhere thereto (see, e.g., FIG. 4, which illustrate a higher concentration of graphene oxide and/or graphite adjacent the surface 36 than the surface 40 because the graphene oxide and graphite layers 44, 42 were applied to the surface 36 in this embodiment). As a result, the interior pores of the substrate 34 are coated substantially with graphene oxide and/or graphite materials. In other embodiments, the graphene oxide and graphite materials may be forced into the interior pores of the substrate 34 by a vacuum pump, a press or by other suitable means. Thereafter, the substrate 34 is allowed to dry to remove residual moisture therefrom.

The graphene oxide/graphite coated substrate 34 is then placed in a nitrogen-rich environment (see FIG. 5). In one embodiment, this is accomplished by placing the substrate 34 in a container 46 made of glass, plastic or other suitable material. The container 46 may either then be filled with a nitrogen-rich gas or may already contain a sufficient amount of nitrogen-rich gas. In one embodiment, ammonia gas may be used. In other embodiments, the container 46 includes an inlet port (not shown) which provides for the continuous introduction of nitrogen-rich gas.

In order to simultaneously accomplish the reduction and nitrogen doping of the graphene oxide material, the container 46 containing the substrate 34 is subjected to microwave radiation. The microwave radiation interacts with the graphite materials on or within the substrate 34 to produce current surges and the electron blasting phenomena, creating glow discharge ammonia plasma. The ammonia plasma leads to the creation of ammonia gas fumes, which, after cooling, deposit the ammonia gas ions on the graphene oxide materials, thereby simultaneously reducing and n-doping the graphene oxide materials. This process may be repeated until a desired concentration of nitrogen reactive sites is achieved. In one embodiment, the atomic concentration of nitrogen in the n-doped graphene in the substrate 34 after the completion of the n-doping process can range from about 2 atomic percent (at. %) to about 12 at. %. In another embodiment, the nitrogen atomic concentration can range from about 2-7.5 at. %. In yet another embodiment, the nitrogen atomic concentration can range from about 7 at. % to about 12 at. %. In other embodiments, the formation of the n-dope graphene layers in the substrate 34 may be carried out using other processes, ranging from chemical vapor deposition (CVD) to carbon-nitride immobilization.

In one embodiment, the container 46 containing the substrate 34 undergoes multiple radiation pulses, whereby the container 46 is subjected to microwave radiation, cooled and subjected to microwave radiation again. In another embodiment, the container 46 is subjected to microwave radiation for about 3-5 seconds and then cooled for about 15-25 minutes before the cycle is repeated to ensure that the container 34 is not structurally harmed. In a further embodiment, this cycle is repeated 3-10 times until the substrate 34 undergoes a color change from brown to a dark grey or black. The microwave radiation may be supplied by industrial microwave radiation production units, commercial microwave radiation production units, or other suitable microwave radiation production unit.

The process of the present invention allows the n-doped graphene particles 26 to be formed and infused substantially throughout the pores 24 of the matrix 18. Because of the large number of pores 24, the n-doped graphene particles 26 create numerous reactive sites within the cathode 12. The nitrogen active sites in the n-doped graphene act as catalysts for the oxygen reduction reaction, increasing the reaction rate.

It should be noted that the present invention can have numerous modifications and variations. For instance, the cathode 12 may be formed of a non-porous material such as glass or the like. In such an embodiment, graphene oxide is applied via a small tube roller to the glass, which is then attached to a ceramic, stone or other similar conventional material with the graphene oxide-coated side facing the contacted material. The cathode 12 may also be coated with n-doped graphene on any number of sides (i.e., two or more sides) of the cathode 12 with the method as described above. Furthermore, anode 14 may be closed to the environment and charged with a sufficient amount of water or other fluid so as to continue the anode side half-cell reaction. Finally, the fuel cell 10 can be provided with an acidic electrolyte within the matrix 18 such as phosphoric acid.

### EXAMPLES

### Overview

An n-doped graphene sample coated over porous silicon carbide was fabricated using the coating and doping method discussed above. This sample was used as the cathode with various metals as the anode, with phosphoric acid.

### Preparation of Graphene Oxide/Silicon Carbide Samples

On a square of porous silicon carbide (220 grit), graphite was drawn over the edges via pencil lead. This graphite was “smeared” using a smooth object, such as rubber, which can spread the graphite layer, and allowing it to be electrically conductive. Using a plastic roller, graphene oxide (2 mg/mL) was coated over the silicon carbide substrate, which was previously saturated with water. Graphene oxide was drawn into the pores of the silicon carbide through a paper towel. The graphene oxide was subsequently dried and placed in a 100 mL glass syringe.

### Production and Transfer of Ammonia Gas

5 mL ammonium hydroxide was put in a 50 mL plastic syringe, which was then covered by a plastic bag and subsequently heated in a microwave oven (900 W) for 5 seconds, to create ammonia gas and water. The ammonia gas was transferred to the 100 mL glass syringe containing the graphene oxide coated over the silicon carbide. Prior to the syringe being capped and sealed, this process was repeated to ensure that the environment contained mostly ammonia gas.

### N-Doping Through Microwave Irradiation

In a fume hood, the 100 mL glass syringe holding the graphene oxide coated over silicon carbide was placed in a microwave oven (900 W) and irradiated for 9 seconds. To prevent the potential breakage of the glass syringe and the substrate, the duration was split into 3 second intervals for three times. During the irradiation of the graphene oxide, glow discharge ammonia plasma and heat were produced by the current surges and electron blasting of graphite, which assisted in the reduction and the doping of graphene oxide. After irradiation was completed, fumes began to accumulate in the syringe, and the syringe was cooled in air for twenty minutes. When the fumes disappeared, the procedure was repeated two more times. The reduction and n-doping of the graphene oxide was determined by the color change, from a brownish green to a dark grey color. Finally, the syringe was uncapped in the fume hood and cooled for 20 minutes, and the sample was then removed.

### Measurement of the Voltage of the Graphene Cathode and Different Metal Anodes (Different Metal Air Cells)

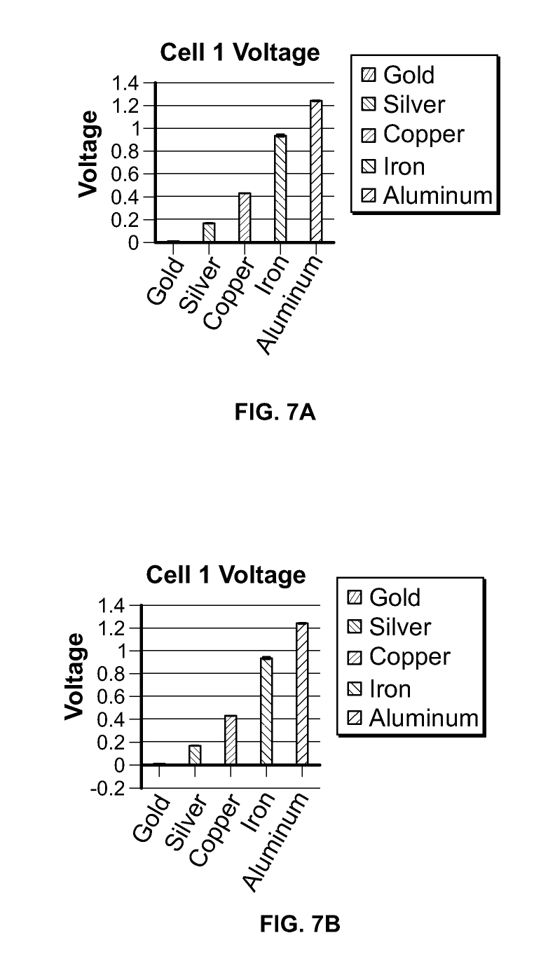

The removed sample was saturated with food-grade 10% phosphoric acid. The cell was placed upright, with the coated sides facing perpendicular to the surface. A small aluminum strip was placed over an uncoated side of the n-doped graphene/silicon carbide sample. Using a multimeter, the probes were connected between the n-doped graphene cathode and the aluminum anode, and the voltage was recorded. The same procedure was repeated with gold, silver, copper, and iron strips as the anode. The voltage measurements observed are shown in FIGS. 7A and 7B. The aluminum strip resulted in approximately 1.2V, the iron strip resulted in approximately 0.9V, the copper strip resulted in approximately 0.4V, the silver strip resulted in approximately 0.08V to approximately 0.16V, and the gold strip resulted in approximately 0.003V to approximately 0V.

It will be understood that the embodiments described herein are merely exemplary and that a person skilled in the art may make many variations and modifications without departing from the spirit and scope of the invention. All such variations and modifications are intended to be included within the scope of the invention, as embodied in the claims presented hereinbelow.

1. A fuel cell electrode, comprising:
a substrate having a plurality of pores, wherein the pores are disposed within the substrate; and
nitrogen-doped graphene disposed within at least one pores.

2. (canceled)

3. The electrode of claim 2, further comprising graphite disposed on a first surface of the substrate.

4. The electrode of claim 3, wherein said nitrogen-doped graphene is uniformly dispersed in said pores of the substrate.

5.-9. (canceled)

10.-21. (canceled)

22.-27. (canceled)

28. The fuel cell electrode of claim 1, wherein the substrate is formed of silicon carbide.

29. The fuel cell electrode of claim 1, wherein the nitrogen-doped graphene is formed in a layer and is in contact with an inside of each of the at least one pores.

30. The fuel cell electrode of claim 1, wherein the pores are interconnected to each other so that water or elemental oxygen is permeable through the substrate.
